(19) United States
(12) Patent Application Publication
(10) Pub. No.: US 2007/0062193 A1
(43) Pub. Date: Mar. 22, 2007

(54) Combustion engine including fluidically-controlled engine valve actuator

(76) Inventors: James R. Weber, Lacon, IL (US); Scott A. Leman, Eureka, IL (US)

Correspondence Address: Finnegan, Henderson, Farabow,;Garrett & Dunner, L.L.P., 901 New York Avenue, N.W., Washington, DC, 20005-3315, US

(21) Appl. No.: 11/504,774

(22) Filed: Aug. 16, 2006

Related U.S. Application Data
(63) Continuation of application No. 10/992,137, filed on Nov. 19, 2004, now abandoned.
Application No. 10/992,137 is a continuation-in-part of application No. 10/933,300, filed on Sep. 3, 2004.
Application No. 10/933,300 is a continuation-in-part of application No. 10/733,570, filed on Dec. 12, 2003, now abandoned.
Application No. 10/733,570 is a continuation of application No. 10/143,908, filed on May 14, 2002, now Pat. No. 6,688,280.
Application No. 10/992,137 is a continuation-in-part of application No. 10/733,570, filed on Dec. 12, 2003, now abandoned.
Application No. 10/733,570 is a continuation of application No. 10/143,908, filed on May 14, 2002, now Pat. No. 6,688,280.
Application No. 10/992,137 is a continuation-in-part of application No. 10/788,431, filed on Feb. 27, 2004.
Application No. 10/788,431 is a continuation of application No. 10/067,030, filed on Feb. 4, 2002, now Pat. No. 6,732,685.

(51) Int. Cl. B60K 6/04; F02B 33/44

(52) U.S. Cl. 60/612; 60/597

(57) ABSTRACT

Engines and methods of controlling an engine may involve one or more fluidically controlled actuators associated with engine intake and/or exhaust valves. In some examples, the actuators may be used to hold valves open. Timing of valve closing/opening and possible use of an air supply system may enable engine operation according to a Miller cycle.

### RELATED APPLICATIONS

This application is a continuation-in-part of U.S. patent application Ser. No. 10/933,300, filed Sep. 3, 2004, which is a continuation-in-part of U.S. patent application Ser. No. 10/733,570, filed Dec. 12, 2003, which is a continuation of U.S. patent application Ser. No. 10/143,908, filed May 14, 2002, now U.S. Pat. No. 6,688,280. This application is also a continuation-in-part of U.S. patent application Ser. No. 10/733,570, filed Dec. 12, 2003, which is a continuation of U.S. patent application Ser. No. 10/143,908, filed May 14, 2002. This application is also a continuation-in-part of U.S. patent application Ser. No. 10/788,431, filed Feb. 27, 2004, which is a continuation of U.S. patent application Ser. No. 10/067,030, filed Feb. 4, 2002, now U.S. Pat. No. 6,732,685.

The entire disclosure of each of the U.S. patent applications and U.S. patents mentioned in the preceding paragraph is incorporated herein by reference. In addition, the entire disclosure of U.S. Pat. No. 6,651,618 is incorporated herein by reference.

### TECHNICAL FIELD

The present invention relates to a combustion engine, an air and fuel supply system for use with an internal combustion engine, and engine valve actuators.

### BACKGROUND

An internal combustion engine may include one or more turbochargers for compressing a fluid, which is supplied to one or more combustion chambers within corresponding combustion cylinders. Each turbocharger typically includes a turbine driven by exhaust gases of the engine and a compressor driven by the turbine. The compressor receives the fluid to be compressed and supplies the compressed fluid to the combustion chambers. The fluid compressed by the compressor may be in the form of combustion air or an air/fuel mixture.

An internal combustion engine may also include a supercharger arranged in series with a turbocharger compressor of an engine. U.S. Pat. No. 6,273,076 (Beck et al., issued Aug. 14, 2001) discloses a supercharger having a turbine that drives a compressor to increase the pressure of air flowing to a turbocharger compressor of an engine.

While a turbocharger may utilize some energy from the engine exhaust, the series supercharger/turbocharger arrangement does not utilize energy from the turbocharger exhaust. Furthermore, the supercharger requires an additional energy source.

The operation of an internal combustion engine involves, among other things, the timed opening and closing of a plurality of valves. For example, with a typical four-stroke, diesel engine, one of ordinary skill in the art will readily recognize such an engine operates through four distinct strokes of a piston reciprocating through a cylinder, with intake and exhaust valves operating in conjunction with the piston. In an intake stroke, the piston descends through the cylinder while an intake valve is open. The resulting vacuum draws air into the cylinder. In a subsequent compression stroke, the piston reverses direction while the intake valve and an exhaust valve are closed, thereby compressing the air within the cylinder. This is followed by a combustion or power stroke wherein fuel is ignited, with the resulting force pushing the piston again in the descending direction while both the intake and exhaust valves are closed. Finally, the piston reverses direction with the exhaust valve open, thereby pushing the combustion gases out of the cylinder.

In certain variations on the typical diesel or Otto cycle, it is desirable to open or close one of the intake and/or exhaust valves at alternative times. For example, in a compression release braking mode, the exhaust valve is opened as the piston approaches a top dead center position during the compression stroke to, in effect, increase engine braking operation. In so doing, the engine cylinders draw in air during the intake stroke, compress the air, and then vent the compressed air out of the exhaust valve near top dead center of the piston.

Another mode of engine operation using particular valve sequencing is known as the Miller cycle. The Miller cycle may reduce the effective compression ratio of the cylinder, which in turn may reduce compression temperature, while maintaining a high expansion ratio. Consequently, a Miller cycle engine may have improved thermal efficiency and reduced exhaust emissions of, for example, oxides of Nitrogen (NOₓ).

One other situation modifying typical valve operation is internal exhaust gas recirculation. One disadvantage of diesel or Otto cycle engine operation is that all of the fuel brought into the cylinder and compressed may not entirely combust. Among other things, this phenomenon may be undesirable due to an unacceptably high level of pollutants, such as nitrous oxide (NOₓ) and particulates, being released during the exhaust stroke.

Exhaust gas recirculation (hereinafter referred to as “EGR”) attempts to curtail such drawbacks of conventional engine operation. With EGR, at least a portion of the exhaust gases is not exhausted to the atmosphere, but rather is introduced back into the engine cylinder to be combusted in subsequent power or combustion strokes of the engine. With typical internal EGR, the exhaust gases are expelled through the exhaust valve and re-introduced to the cylinder through the exhaust valve itself. Such a process requires that the exhaust valve stay open not only through the exhaust stroke, but also on the intake stroke, after the piston reverses direction, thereby creating a vacuum and drawing a portion of the exhaust gases back into the cylinder through the still open exhaust valve.

One of ordinary skill in the art will readily appreciate that a substantial force may be required to open the exhaust valve and maintain the valve in an open position as the piston reciprocates through the cylinder toward the top dead center position. A valve actuator employing highly pressurized oil may be used to apply this force to open the exhaust valve.

Holding an exhaust valve in an open position by a valve actuator employing highly pressurized oil sometimes requires, for example, pressurized oil on the order of fifteen hundred to five thousand pounds per square inch (10.34 to 34.4 MPa). The engine or machine in which such an engine has been mounted therefore may need to provide a high pressure source or high pressure rail and be able to supply the high pressure oil to the actuator when desired. Such a high pressure supply has, among other things, the disadvantage, at least with respect to Miller cycle and EGR operation, of decreasing the engine efficiency in that the engine may need to continually direct usable work to the high pressure rail to maintain such pressures even though the high pressure oil is only required for a relatively short duration during the engine operation. Not only is the provision of such pressurized fluid taxing on the efficiency of the engine, but with certain machines the provision of such a high pressure rail is simply not available or desirable.

The present disclosure is directed to possibly addressing one or more of the drawbacks associated with some prior approaches.

### SUMMARY

In accordance with one exemplary aspect according to the present disclosure, there is a method of operating an internal combustion engine including at least one cylinder and a piston slidable in the cylinder. The method may include supplying pressurized air from an intake manifold to an air intake port of a combustion chamber in the cylinder. An air intake valve may be operated to open the air intake port to allow pressurized air to flow between the combustion chamber and the intake manifold substantially during a majority portion of a compression stroke of the piston. The operating of the air intake valve may include operating a fluidically controlled actuator to hold the intake valve open.

Another exemplary aspect relates to an internal combustion engine. The engine may include an engine block defining at least one cylinder, and a head connected with said engine block, the head including an air intake port, and an exhaust port. A piston may be slidable in the cylinder, and a combustion chamber may be defined by said head, said piston, and said cylinder. An air intake valve may be controllably movable to open and close the air intake port. An air supply system may include at least one turbocharger fluidly connected to the air intake port. A fuel supply system may be operable to inject fuel into the combustion chamber. The engine may also include a source of pressurized fluid. A fluidically controlled actuator may be associated with the air intake valve and the source of pressurized fluid. The engine may be configured to operate the air intake valve via at least the fluidically controlled actuator.

An additional aspect may relate to a method of operating an internal combustion engine, including imparting rotational movement to a first turbine and a first compressor of a first turbocharger with exhaust air flowing from an exhaust port of the cylinder, and imparting rotational movement to a second turbine and a second compressor of a second turbocharger with exhaust air flowing from an exhaust duct of the first turbocharger. Air drawn from atmosphere may be compressed with the second compressor. Air received from the second compressor may be compressed with the first compressor. Pressurized air may be supplied from the first compressor to an air intake port of a combustion chamber in the cylinder via an intake manifold. A fuel supply system may be operated to inject fuel directly into the combustion chamber. The method may involve operating an air intake valve to open the air intake port to allow pressurized air to flow between the combustion chamber and the intake manifold. The operating of the air intake valve may include operating a fluidically controlled actuator to hold the intake valve open.

A further aspect may relate to a method of controlling an internal combustion engine having a variable compression ratio, said engine including a block defining a cylinder, a piston slidable in said cylinder, and a head connected with said block, said piston, said cylinder, and said head defining a combustion chamber. The method may include pressurizing air, and supplying said air to an intake manifold of the engine. The method may also include maintaining fluid communication between said combustion chamber and the intake manifold during a portion of an intake stroke and through a portion of a compression stroke. The maintaining may include operating a fluidically controlled actuator to hold an air intake valve open. Fuel may be injected directly into the combustion chamber.

Yet another aspect may relate to a method of operating an internal combustion engine including at least one cylinder and a piston slidable in the cylinder. The method may include supplying pressurized air from an intake manifold to an air intake port of a combustion chamber in the cylinder, and operating an air intake valve to open the air intake port to allow pressurized air to flow between the combustion chamber and the intake manifold substantially during a portion of a compression stroke of the piston. The operation of the air intake valve may include operating a fluidically controlled actuator to hold the intake valve open. The method may also include injecting fuel into the combustion chamber after the intake valve is closed, wherein the injecting may include supplying a pilot injection of fuel at a crank angle before a main injection of fuel.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate several exemplary embodiments of the invention and, together with the description, serve to explain the principles of the invention. In the drawings,

FIG. 1 is a combination diagrammatic and schematic illustration of an exemplary air supply system for an internal combustion engine in accordance with the invention;

FIG. 2 is a combination diagrammatic and schematic illustration of an exemplary engine cylinder in accordance with the invention;

FIG. 3 is a diagrammatic sectional view of the exemplary engine cylinder of FIG. 2;

FIG. 4 is a diagrammatic and schematic cross-sectional view of an example of an internal combustion engine including the cylinder of FIG. 2 and an engine valve actuator;

FIG. 5 is cross-sectional view of the engine of FIG. 4, taken along line 5-5 of FIG. 4;

FIG. 6 is a schematic representation of an engine valve actuator shown in a first position;

FIG. 7 is a schematic representation of an engine valve actuator shown in a second position;

FIG. 8 is a schematic representation of an engine valve actuator shown in a third position;

FIG. 9 is a graph illustrating an exemplary intake valve actuation as a function of engine crank angle in accordance with the present invention;

FIG. 10 is a graph illustrating an exemplary fuel injection as a function of engine crank angle in accordance with the present invention;

FIG. 11 is a combination diagrammatic and schematic illustration of another exemplary air supply system for an internal combustion engine in accordance with the invention;

FIG. 12 is a combination diagrammatic and schematic illustration of yet another exemplary air supply system for an internal combustion engine in accordance with the invention;

FIG. 13 is a combination diagrammatic and schematic illustration of an exemplary exhaust gas recirculation system included as part of an internal combustion engine in accordance with the invention;

FIG. 14 is a flow chart depicting a sample sequence of steps which may be taken to operate an internal combustion engine valve actuator;

FIG. 15 is a graph plotting exemplary valve lift vs. engine crank angle during normal operation for an example of an engine according to the present disclosure;

FIG. 16 is a graph plotting exemplary valve lift vs. engine crank angle during internal exhaust gas recirculation operation;

FIG. 17 is a graph plotting an example of valve lift vs. engine crank angle during Miller cycle operation; and

FIG. 18 is a schematic representation of an alternative engine valve actuator configuration.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

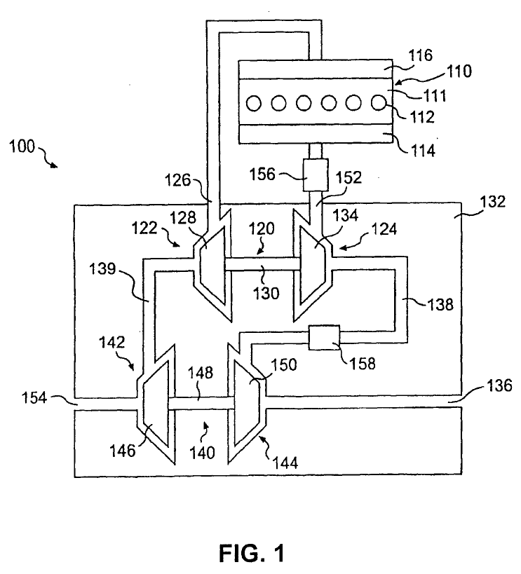

Referring to FIG. 1, an exemplary air supply system 100 for an internal combustion engine 110, for example, a four-stroke, diesel engine, is provided. While the engine 110 is depicted and will be described in further detail herein with reference to a four stroke, internal combustion diesel engine, it is to be understood that the teachings of the disclosure can be employed in conjunction with any other type of engine as well. The internal combustion engine 110 includes an engine block 111 defining a plurality of combustion cylinders 112, the number of which depends upon the particular application. For example, a 4-cylinder engine would include four combustion cylinders, a 6-cylinder engine would include six combustion cylinders, etc. In the exemplary embodiment of FIG. 1, six combustion cylinders 112 are shown. It should be appreciated that the engine 110 may be any other type of internal combustion engine, for example, a gasoline or natural gas engine.

The internal combustion engine 110 also includes an intake manifold 114 and an exhaust manifold 116. The intake manifold 114 provides fluid, for example, air or a fuel/air mixture, to the combustion cylinders 112. The exhaust manifold 116 receives exhaust fluid, for example, exhaust gas, from the combustion cylinders 112. The intake manifold 114 and the exhaust manifold 116 are shown as a single-part construction for simplicity in the drawing. However, it should be appreciated that the intake manifold 114 and/or the exhaust manifold 116 may be constructed as multi-part manifolds, depending upon the particular application.\

The air supply system 100 includes a first turbocharger 120 and may include a second turbocharger 140. The first and second turbochargers 120, 140 may be arranged in series with one another such that the second turbocharger 140 provides a first stage of pressurization and the first turbocharger 120 provides a second stage of pressurization. For example, the second turbocharger 140 may be a low pressure turbocharger and the first turbocharger 120 may be a high pressure turbocharger. The first turbocharger 120 includes a turbine 122 and a compressor 124. The turbine 122 is fluidly connected to the exhaust manifold 116 via an exhaust duct 126. The turbine 122 includes a turbine wheel 128 carried by a shaft 130, which in turn may be rotatably carried by a housing 132, for example, a single-part or multi-part housing. The fluid flow path from the exhaust manifold 116 to the turbine 122 may include a variable nozzle (not shown) or other variable geometry arrangement adapted to control the velocity of exhaust fluid impinging on the turbine wheel 128.

The compressor 124 includes a compressor wheel 134 carried by the shaft 130. Thus, rotation of the shaft 130 by the turbine wheel 128 in turn may cause rotation of the compressor wheel 134.

The first turbocharger 120 may include a compressed air duct 138 for receiving compressed air from the second turbocharger 140 and an air outlet line 152 for receiving compressed air from the compressor 124 and supplying the compressed air to the intake manifold 114 of the engine 110. The first turbocharger 120 may also include an exhaust duct 139 for receiving exhaust fluid from the turbine 122 and supplying the exhaust fluid to the second turbocharger 140.

The second turbocharger 140 may include a turbine 142 and a compressor 144. The turbine 142 may be fluidly connected to the exhaust duct 139. The turbine 142 may include a turbine wheel 146 carried by a shaft 148, which in turn may be rotatably carried by the housing 132. The compressor 144 may include a compressor wheel 150 carried by the shaft 148. Thus, rotation of the shaft 148 by the turbine wheel 146 may in turn cause rotation of the compressor wheel 150.

The second turbocharger 140 may include an air intake line 136 providing fluid communication between the atmosphere and the compressor 144. The second turbocharger 140 may also supply compressed air to the first turbocharger 120 via the compressed air duct 138. The second turbocharger 140 may include an exhaust outlet 154 for receiving exhaust fluid from the turbine 142 and providing fluid communication with the atmosphere. In an embodiment, the first turbocharger 120 and second turbocharger 140 may be sized to provide substantially similar compression ratios. For example, the first turbocharger 120 and second turbocharger 140 may both provide compression ratios of between 2 to 1 and 3 to 1, resulting in a system compression ratio of at least 4:1 with respect to atmospheric pressure. Alternatively, the second turbocharger 140 may provide a compression ratio of 3 to 1 and the first turbocharger 120 may provide a compression ratio of 1.5 to 1, resulting in a system compression ratio of 4.5 to 1 with respect to atmospheric pressure.

The air supply system 100 may include an air cooler 156, for example, an aftercooler, between the compressor 124 and the intake manifold 114. The air cooler 156 may extract heat from the air to lower the intake manifold temperature and increase the air density. Optionally, the air supply system 100 may include an additional air cooler 158, for example, an intercooler, between the compressor 144 of the second turbocharger 140 and the compressor 124 of the first turbocharger 120. Intercooling may use techniques such as jacket water, air to air, and the like. Alternatively, the air supply system 100 may optionally include an additional air cooler (not shown) between the air cooler 156 and the intake manifold 114. The optional additional air cooler may further reduce the intake manifold temperature. A jacket water pre-cooler (not shown) may be used to protect the air cooler 156.

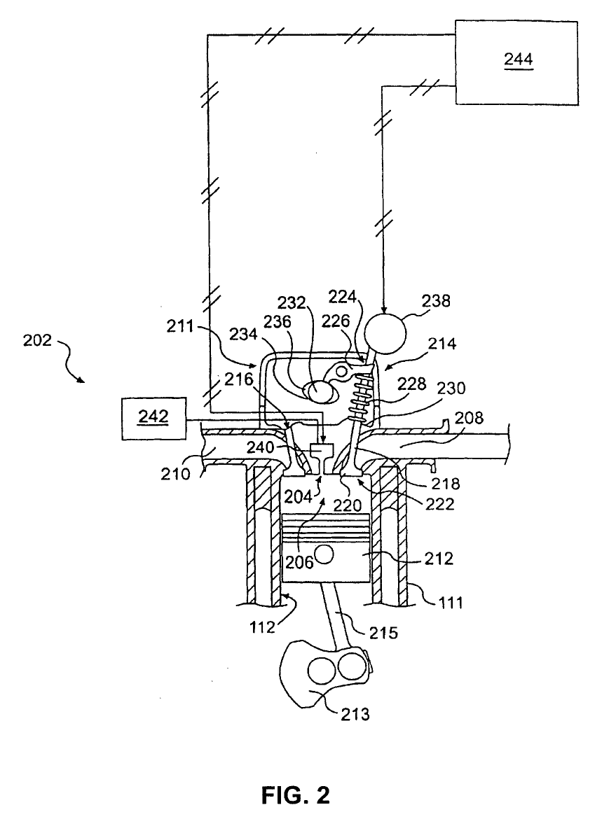

Referring now to FIG. 2, a cylinder head 211 may be connected with the engine block 111. Each cylinder 112 in the cylinder head 211 may be provided with a fuel supply system 202. The fuel supply system 202 may include a fuel port 204 opening to a combustion chamber 206 within the cylinder 112. The fuel supply system 202 may inject fuel, for example, diesel fuel, directly into the combustion chamber 206.

The cylinder 112 may contain a piston 212 slidably movable in the cylinder. A crankshaft 213 may be rotatably disposed within the engine block 111. A connecting rod 215 may couple the piston 212 to the crankshaft 213 so that sliding motion of the piston 212 within the cylinder 112 results in rotation of the crankshaft 213. Similarly, rotation of the crankshaft 213 results in a sliding motion of the piston 212. For example, an uppermost position of the piston 212 in the cylinder 112 corresponds to a top dead center position of the crankshaft 213, and a lowermost position of the piston 212 in the cylinder 112 corresponds to a bottom dead center position of the crankshaft 213.

As one skilled in the art will recognize, the piston 212 in a conventional, four-stroke engine cycle reciprocates between the uppermost position and the lowermost position during a combustion (or expansion) stroke, an exhaust stroke, and intake stroke, and a compression stroke. Meanwhile, the crankshaft 213 rotates from the top dead center position to the bottom dead center position during the combustion stroke, from the bottom dead center to the top dead center during the exhaust stroke, from top dead center to bottom dead center during the intake stroke, and from bottom dead center to top dead center during the compression stroke. Then, the four-stroke cycle begins again. Each piston stroke correlates to about 180° of crankshaft rotation, or crank angle. Thus, the combustion stroke may begin at about 0° crank angle, the exhaust stroke at about 180°, the intake stroke at about 360°, and the compression stroke at about 540°.

The cylinder 112 may include at least one intake port 208 and at least one exhaust port 210, each opening to the combustion chamber 206. The intake port 208 may be opened and closed by an intake valve assembly 214, and the exhaust port 210 may be opened and closed by an exhaust valve assembly 216. The intake valve assembly 214 may include, for example, an intake valve 218 having a head 220 at a first end 222, with the head 220 being sized and arranged to selectively close the intake port 208. The second end 224 of the intake valve 218 may be connected to a rocker arm 226 or any other conventional valve-actuating mechanism. The intake valve 218 may be movable between a first position permitting flow from the intake manifold 114 to enter the combustion cylinder 112 and a second position substantially blocking flow from the intake manifold 114 to the combustion cylinder 112. A spring 228 may be disposed about the intake valve 218 to bias the intake valve 218 to the second, closed position.

A camshaft 232 carrying a cam 234 with one or more lobes 236 may be arranged to operate the intake valve assembly 214 cyclically based on the configuration of the cam 234, the lobes 236, and the rotation of the camshaft 232 to achieve a desired intake valve timing. The exhaust valve assembly 216 may be configured in a manner similar to the intake valve assembly 214 and may be operated by one of the lobes 236 of the cam 234. In an embodiment, the intake lobe 236 may be configured to operate the intake valve 218 in a conventional Otto or diesel cycle, whereby the intake valve 218 moves to the second position from between about 10° before bottom dead center of the intake stroke and about 10° after bottom dead center of the compression stroke. Alternatively (or additionally), the intake valve assembly 214 and/or the exhaust valve assembly 216 may be operated hydraulically, pneumatically, electronically, or by any combination of mechanics, hydraulics, pneumatics, and/or electronics.

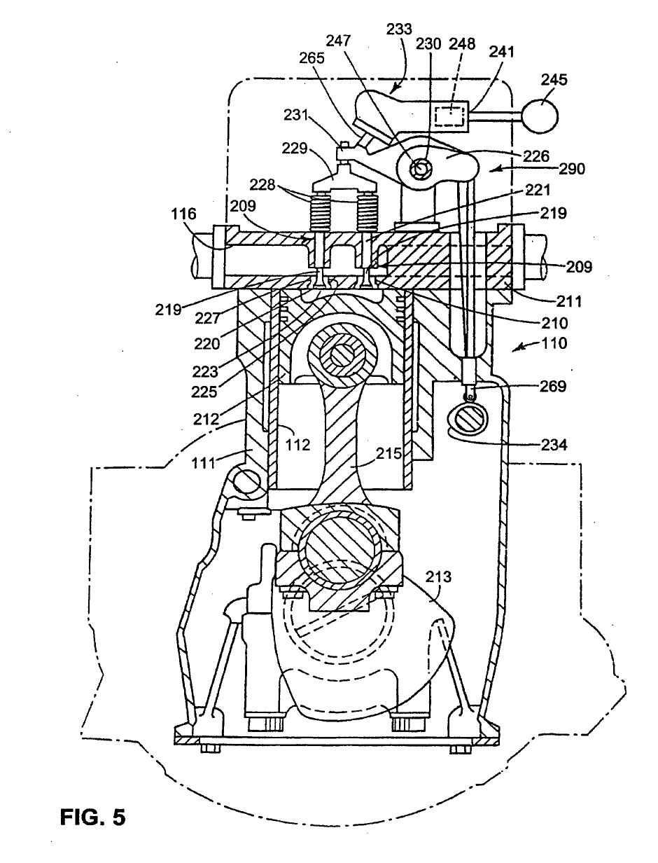

The intake valve assembly 214 may include a variable intake valve closing mechanism 238 structured and arranged to selectively interrupt cyclical movement of and extend the closing timing of the intake valve 218. The variable intake valve closing mechanism 238 may be operated hydraulically, pneumatically, electronically, mechanically, or any combination thereof. For example, the variable intake valve closing mechanism 238 may be selectively operated to supply hydraulic fluid, for example, at a low pressure or a high pressure, in a manner to resist closing of the intake valve 218 by the bias of the spring 228, as described below in connection with an actuator 233 shown in FIGS. 5-8. That is, after the intake valve 218 is lifted, i.e., opened, by the cam 234, and when the cam 234 is no longer holding the intake valve 218 open, the hydraulic fluid may hold the intake valve 218 open for a desired period. The desired period may change depending on the desired performance of the engine 110. Thus, the variable intake valve closing mechanism 238 may enable the engine 110 to operate under a conventional Otto or diesel cycle or under a variable late-closing and/or variable early-closing Miller cycle.

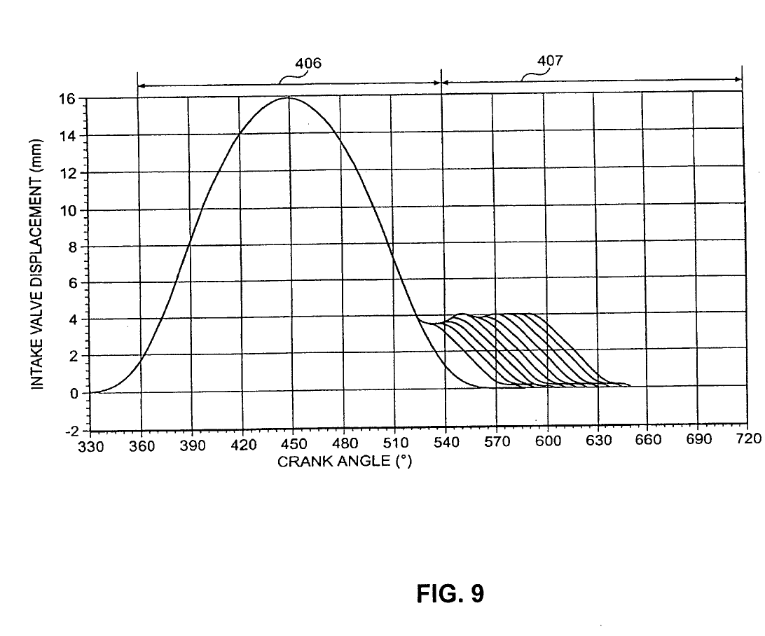

As shown in FIG. 9, the intake valve 218 may begin to open at about 360° crank angle, that is, when the crankshaft 213 is at or near a top dead center position of an intake stroke 406. The closing of the intake valve 218 may be selectively varied from about 540° crank angle, that is, when the crank shaft is at or near a bottom dead center position of a compression stroke 407, to about 650° crank angle, that is, about 70° before top center of the combustion stroke 508. Thus, the intake valve 218 may be held open for a majority portion of the compression stroke 407, that is, for more than half of the compression stroke 407, e.g., the first half of the compression stroke 407 and a portion of the second half of the compression stroke 407. Rather than (or in addition to sometimes) having the intake valve close at or after bottom dead center of the compression stroke, engine 110 may be configured to close the intake valve early. For example, the profile of cams 234 and/or control of actuator 233 described below may be arranged such that the engine may be configured to selectively provide early and/or late intake valve closure.

The fuel supply system 202 may include a fuel injector assembly 240, for example, a mechanically-actuated, electronically-controlled unit injector, in fluid communication with a common fuel rail 242. Alternatively, the fuel injector assembly 240 may be any common rail type injector and may be actuated and/or operated hydraulically, mechanically, electrically, piezo-electrically, or any combination thereof. The common fuel rail 242 provides fuel to the fuel injector assembly 240 associated with each cylinder 112. The fuel injector assembly 240 may inject or otherwise spray fuel into the cylinder 112 via the fuel port 204 in accordance with a desired timing.

A controller 244 may be electrically connected to the variable intake valve closing mechanism 238 and/or the fuel injector assembly 240. The controller 244 may be configured to control operation of the variable intake valve closing mechanism 238 (e.g., actuator 233 shown in FIGS. 5-8) and/or the fuel injector assembly 240 based on one or more engine conditions, for example, engine speed, load, pressure, and/or temperature in order to achieve a desired engine performance. It should be appreciated that the functions of the controller 244 may be performed by a single controller or by a plurality of controllers. Similarly, spark timing in a natural gas engine may provide a similar function to fuel injector timing of a compression ignition engine.

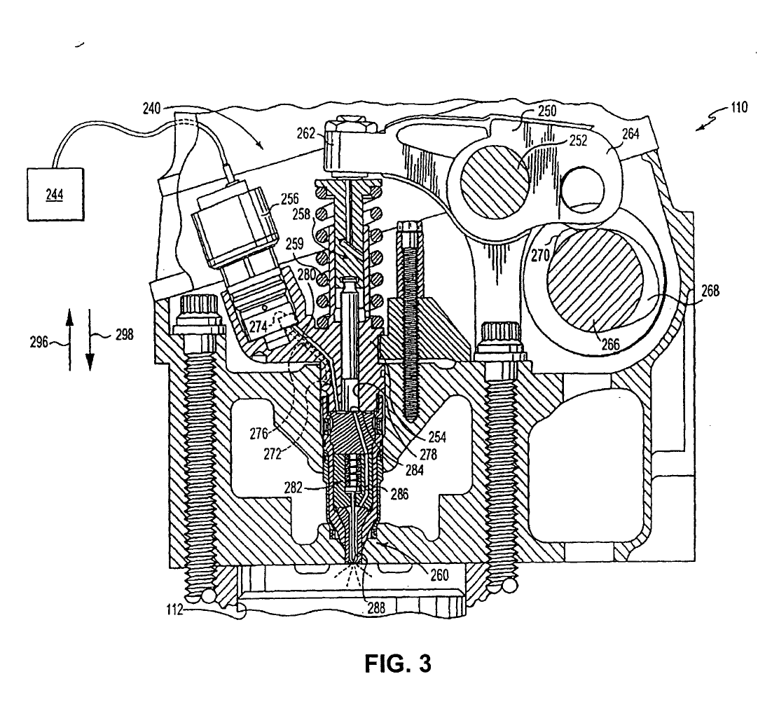

Referring now to FIG. 3, each fuel injector assembly 240 may be associated with an injector rocker arm 250 pivotally coupled to a rocker shaft 252. Each fuel injector assembly 240 may include an injector body 254, a solenoid 256, a plunger assembly 258, and an injector tip assembly 260. A first end 262 of the injector rocker arm 250 may be operatively coupled to the plunger assembly 258. The plunger assembly 258 may be biased by a spring 259 toward the first end 262 of the injector rocker arm 250 in the general direction of arrow 296.

A second end 264 of the injector rocker arm 250 may be operatively coupled to a camshaft 266. More specifically, the camshaft 266 may include a cam lobe 267 having a first bump 268 and a second bump 270. The camshafts 232, 266 and their respective lobes 236, 267 may be combined into a single camshaft (not shown) if desired. The bumps 268, 270 may be moved into and out of contact with the second end 264 of the injector rocker arm 250 during rotation of the camshaft 266. The bumps 268, 270 may be structured and arranged such that the second bump 270 may provide a pilot injection of fuel at a predetermined crank angle before the first bump 268 provides a main injection of fuel. It should be appreciated that the cam lobe 267 may have only a first bump 268 that injects all of the fuel per cycle.

When one of the bumps 268, 270 is rotated into contact with the injector rocker arm 250, the second end 264 of the injector rocker arm 250 is urged in the general direction of arrow 296. As the second end 264 is urged in the general direction of arrow 296, the rocker arm 250 pivots about the rocker shaft 252 thereby causing the first end 262 to be urged in the general direction of arrow 298. The force exerted on the second end 264 by the bumps 268, 270 is greater in magnitude than the bias generated by the spring 259, thereby causing the plunger assembly 258 to be likewise urged in the general direction of arrow 298. When the camshaft 266 is rotated beyond the maximum height of the bumps 268, 270, the bias of the spring 259 urges the plunger assembly 258 in the general direction of arrow 296. As the plunger assembly 258 is urged in the general direction of arrow 296, the first end 262 of the injector rocker arm 250 is likewise urged in the general direction of arrow 296, which causes the injector rocker arm 250 to pivot about the rocker shaft 252 thereby causing the second end 264 to be urged in the general direction of arrow 298.

The injector body 254 defines a fuel port 272. Fuel, such as diesel fuel, may be drawn or otherwise aspirated into the fuel port 272 from the fuel rail 242 when the plunger assembly 258 is moved in the general direction of arrow 296. The fuel port 272 is in fluid communication with a fuel valve 274 via a first fuel channel 276. The fuel valve 274 is, in turn in fluid communication with a plunger chamber 278 via a second fuel channel 280.

The solenoid 256 may be electrically coupled to the controller 244 and mechanically coupled to the fuel valve 274. Actuation of the solenoid 256 by a signal from the controller 244 may cause the fuel valve 274 to be switched from an open position to a closed position. When the fuel valve 274 is positioned in its open position, fuel may advance from the fuel port 272 to the plunger chamber 278, and vice versa. However, when the fuel valve 274 is positioned in its closed positioned, the fuel port 272 is isolated from the plunger chamber 278.

The injector tip assembly 260 may include a check valve assembly 282. Fuel may be advanced from the plunger chamber 278, through an inlet orifice 284, a third fuel channel 286, an outlet orifice 288, and into the cylinder 112 of the engine 110.

Thus, it should be appreciated that when one of the bumps 268, 270 is not in contact with the injector rocker arm 16, the plunger assembly 258 is urged in the general direction of arrow 296 by the spring 259 thereby causing fuel to be drawn into the fuel port 272 which in turn fills the plunger chamber 278 with fuel. As the camshaft 266 is further rotated, one of the bumps 268, 270 is moved into contact with the rocker arm 250, thereby causing the plunger assembly 258 to be urged in the general direction of arrow 298. If the controller 244 is not generating an injection signal, the fuel valve 274 remains in its open position, thereby causing the fuel which is in the plunger chamber 278 to be displaced by the plunger assembly 258 through the fuel port 272. However, if the controller 244 is generating an injection signal, the fuel valve 274 is positioned in its closed position thereby isolating the plunger chamber 278 from the fuel port 272. As the plunger assembly 258 continues to be urged in the general direction of arrow 298 by the camshaft 266, fluid pressure within the fuel injector assembly 240 increases. At a predetermined pressure magnitude, for example, at about 5500 psi (38 MPa), fuel is injected into the cylinder 112. Fuel will continue to be injected into the cylinder 112 until the controller 244 signals the solenoid 256 to return the fuel valve 274 to its open position.

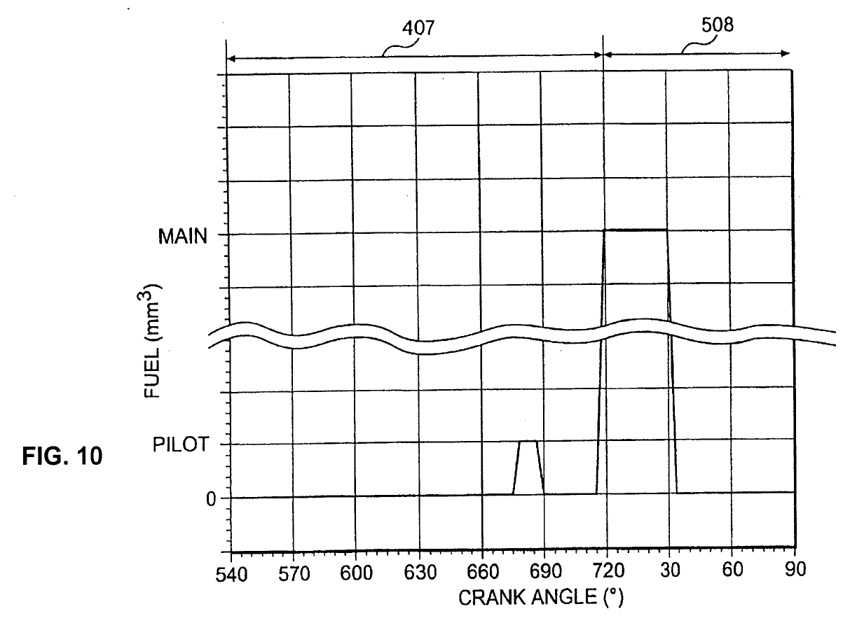

As shown in the exemplary graph of FIG. 10, the pilot injection of fuel may commence when the crankshaft 213 is at about 675° crank angle, that is, about 45° before top dead center of the compression stroke 407. The main injection of fuel may occur when the crankshaft 213 is at about 710° crank angle, that is, about 10° before top dead center of the compression stroke 407 and about 45° after commencement of the pilot injection. Generally, the pilot injection may commence when the crankshaft 213 is about 40-50° before top dead center of the compression stroke 407 and may last for about 10-15° crankshaft rotation. The main injection may commence when the crankshaft 213 is between about 10° before top dead center of the compression stroke 407 and about 12° after top dead center of the combustion stroke 508. The main injection may last for about 20-45° crankshaft rotation. The pilot injection may use a desired portion of the total fuel used, for example about 10%.

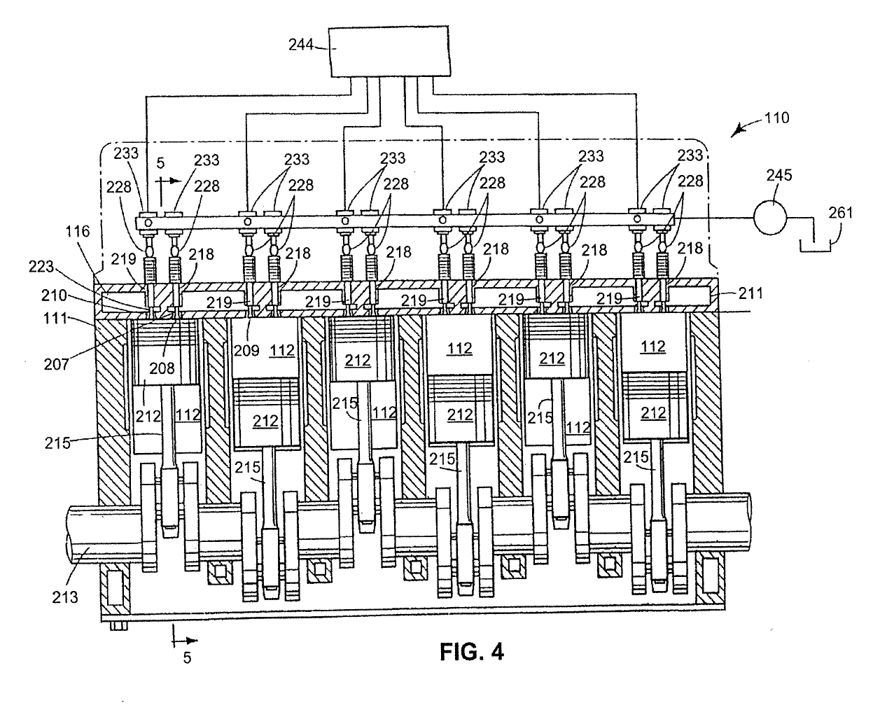

As shown in FIG. 4, the engine 110 may include six engine cylinders 112 and engine pistons 212 in aligned fashion. (It is to be understood that a greater or lesser number of cylinders/pistons are possible, and that cylinder orientations other than in-line, such as “V”, are possible as well.) Each respective connecting rod 215 may be connected to each piston 212, and in turn be connected to the crankshaft 213 so as to capitalize on the motion of the piston 212 to produce useful work in a machine (not shown) with which the engine 110 is associated. Each engine cylinder 212 may be defined by the engine block 111 having cylinder head 211, and further include the intake valve 218, and an exhaust valve 219.

Referring now to FIGS. 4-5, the cylinder head 211, and a pair of exhaust valves 219 are shown in greater detail for one of the engine cylinders 112. As shown therein, a pair of exhaust ports 210 may be provided in the cylinder head 211 to allow for fluid communication into and out of the engine cylinder 112. In addition, while FIG. 4 depicts only one intake port 208 per cylinder 112, it is to be understood that a pair of intake ports 208 may be provided in each cylinder 112 in a manner similar to the exhaust ports 210 depicted in FIG. 5. In some modes of engine operation, air may be allowed to enter the engine cylinder 112 through the intake ports 208, while combustion or exhaust gases may be allowed to exit the engine cylinder 112 through the exhaust ports 210. An intake valve element 207 may be provided within each intake port 208, while an exhaust valve element 209 may be provided within each exhaust port 210.

Each of the valve elements 207, 209 may include a valve head 220 from which a valve stem 221 extends. The valve head 220 includes a sealing surface 223 adapted to seal against a valve seat 225 about a perimeter 227 of the valve ports 208, 210. The valve elements 207, 209 further include a bridge 229 adapted to contact the valve stems 221 associated with each engine cylinder 112. A valve spring 228 imparts force between the top of each valve stem 221 and the cylinder head 211, thereby biasing the stem 221 away from the cylinder head 211 and thus biasing the valve head 220 into seating engagement with the corresponding valve seats 225 to close the intake and exhaust valves 218, 219.

As shown best in FIG. 5, movement of the valve elements 207, 209 may be controlled not only by the springs 228, but by a cam assembly 290 as well. As one of ordinary skill in the art will readily recognize, rotation of the cam 234 periodically causes a push rod 269 to rise, thereby causing a rocker arm 226, connected thereto, to pivot about a pivot 230. In so doing, an end 231 of the rocker arm 226 is caused to move downwardly and thereby open the exhaust valve element 209. Under normal engine operation, the cam 234 imparts sufficient force to the valve stem 221 to overcome the biasing force of the spring 228 and thereby push the valve head 220 away from the valve seat 225, to open the exhaust valves 219 (or intake valve 218). Further rotation of the cam 234 allows the spring 228 to push the end 231 of the rocker arm 226 upward and the push rod 269 downward until the cam 234 completes another revolution.

In certain modes of engine operation, such as with the compression release braking, some examples of Miller cycle operation, and EGR referenced above, it may be desirable for the intake and/or exhaust valves 218, 219 to be held open for longer periods, or at a timing sequence other than that dictated by the cam 234. In such situations, valve actuator 233 may be used to hold the intake valve 218 and/or exhaust valve 219 open. As shown in FIGS. 5-8, one example of the valve actuator 233 includes an actuator cylinder 235 in which an actuator piston 237 is reciprocatingly disposed. The actuator cylinder 235 may include an opening 239, through which an actuator rod 265 may extend in the direction of the rocker arm 226 and the valve stem 221 as well.

The actuator cylinder 235 may also include a port 241 providing access to an actuation chamber 243. The port 241 is adapted to place the actuation chamber 243 into fluid communication with a low pressure fluid source 245. In one embodiment, the pressurized fluid may be lubrication oil of the engine 110 (typically at a pressure level less than one hundred pounds per square inch, for example, on the order of sixty to ninety pounds per square inch (413.7 KPa to 620.5 KPa)). (Alternatively, the fluid source 245 could be a high pressure fluid source.) Placement of the fluid source 245 into fluid communication with the actuation chamber 243 may be provided through a fluid passage 247 and be controlled by a control valve 248. The control valve 248 may include an inlet 251 and an outlet 253. The control valve 248 may be biased into a first position connecting the port 241 to the low pressure fluid source 245 and be actuated by a solenoid 255 to a second position disconnecting the port 241 from the low pressure fluid source 245. The solenoid 255 may itself be actuated upon receipt of a control signal or the like from a main control or processor 244 (FIG. 4) of the engine 110. The fluid source 245 may be in fluid communication with an oil drain, sump, or accumulator 261, for example, via a check valve.

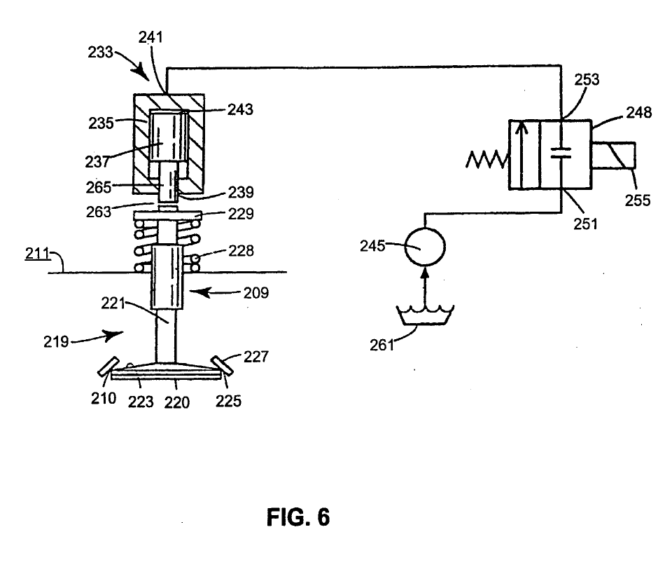

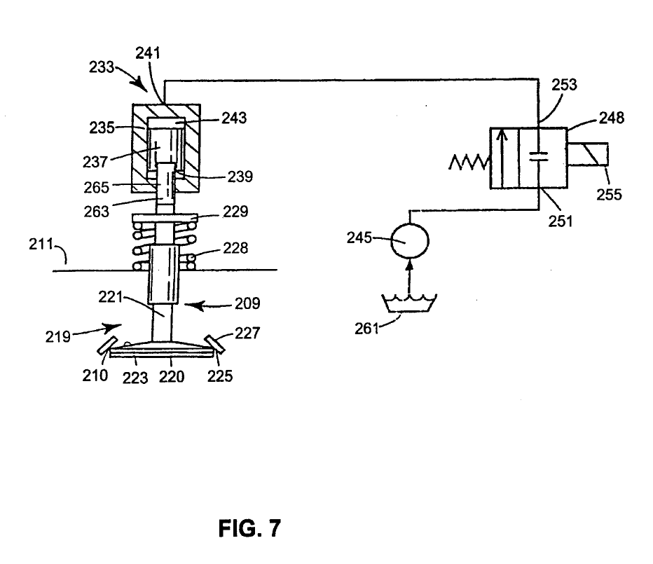

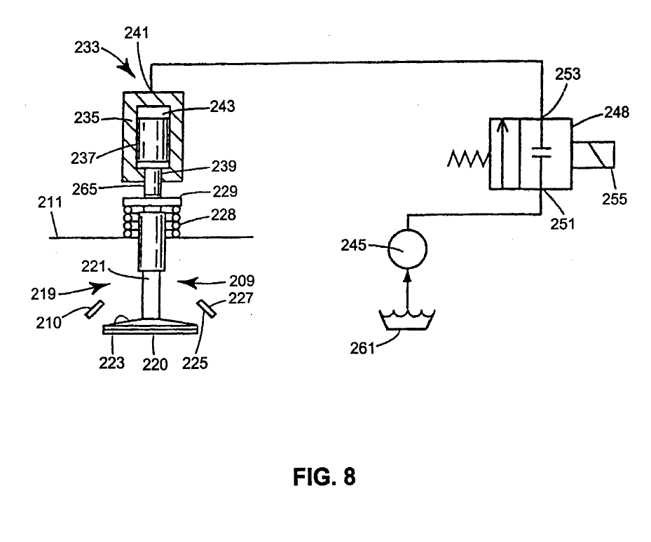

The low pressure fluid source 245, when the control valve 248 is in the first position (FIG. 7), is able to fill the actuator chamber 243 sufficiently to move the actuator piston 237 so as to take up any lash 263 (FIG. 6) existing in the system, such as that between the actuator rod 265 and the valve stem 221 or between the actuator rod 265 and the rocker arm 226. “Taking up any lash in the system” is defined herein to mean removing any space between movable components. In so doing, when it is desired to hold the exhaust valve 219 in an open position, the control valve 248 can be moved to the second position (FIG. 8) thereby disconnecting the inlet 251 and hydraulically locking the actuator 233. Pressure within the engine cylinder 112 imparts force on the exhaust valve 219, and in turn the actuator rod 265, but the fluid within the actuator cylinder 235, being incompressible and locked, holds the actuator piston 237, and thus the exhaust valve 219 (or intake valve 218), in the open position.

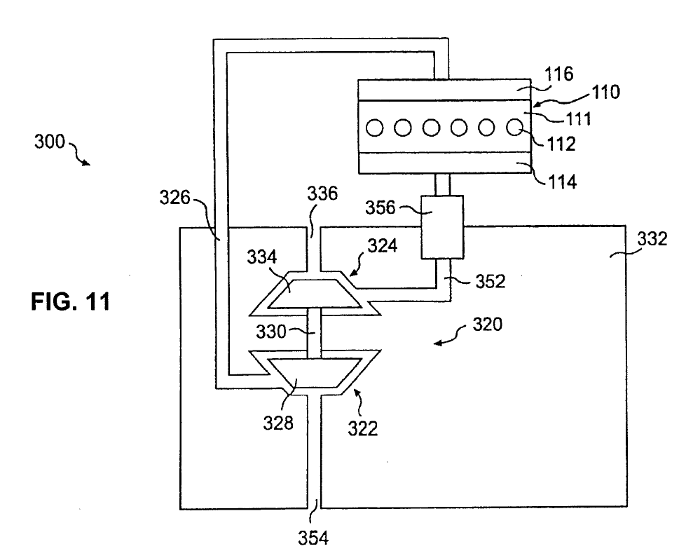

FIG. 11 is a combination diagrammatic and schematic illustration of an alternative exemplary air supply system 300 for the internal combustion engine 110. The air supply system 300 may include a turbocharger 320, for example, a high-efficiency turbocharger capable of producing at least about a 4 to 1 compression ratio with respect to atmospheric pressure. The turbocharger 320 may include a turbine 322 and a compressor 324. The turbine 322 may be fluidly connected to the exhaust manifold 116 via an exhaust duct 326. The turbine 322 may include a turbine wheel 328 carried by a shaft 330, which in turn may be rotatably carried by a housing 332, for example, a single-part or multi-part housing. The fluid flow path from the exhaust manifold 116 to the turbine 322 may include a variable nozzle (not shown), which may control the velocity of exhaust fluid impinging on the turbine wheel 328.

The compressor 324 may include a compressor wheel 334 carried by the shaft 330. Thus, rotation of the shaft 330 by the turbine wheel 328 in turn may cause rotation of the compressor wheel 334. The turbocharger 320 may include an air inlet 336 providing fluid communication between the atmosphere and the compressor 324 and an air outlet 352 for supplying compressed air to the intake manifold 114 of the engine 110. The turbocharger 320 may also include an exhaust outlet 354 for receiving exhaust fluid from the turbine 322 and providing fluid communication with the atmosphere.

The air supply system 300 may include an air cooler 356 between the compressor 324 and the intake manifold 114. Optionally, the air supply system 300 may include an additional air cooler (not shown) between the air cooler 356 and the intake manifold 114.

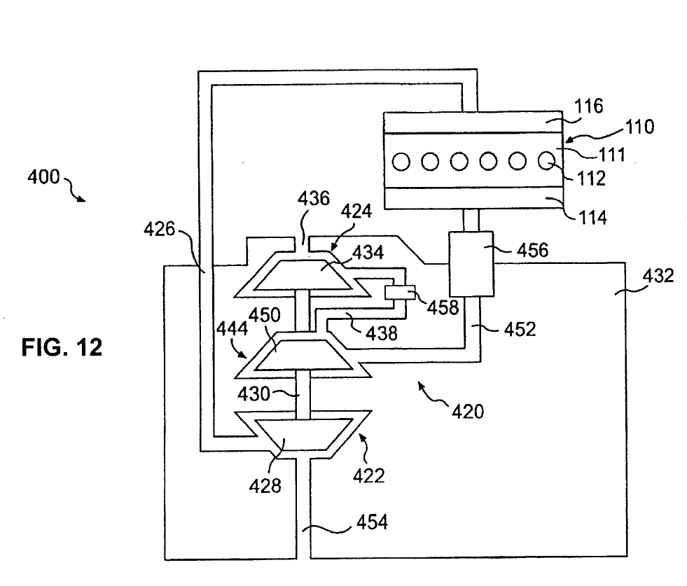

FIG. 12 is a combination diagrammatic and schematic illustration of another alternative exemplary air supply system 400 for the internal combustion engine 110. The air supply system 400 may include a turbocharger 420, for example, a turbocharger 420 having a turbine 422 and two compressors 424, 444. The turbine 422 may be fluidly connected to the exhaust manifold 116 via an inlet duct 426. The turbine 422 may include a turbine wheel 428 carried by a shaft 430, which in turn may be rotatably carried by a housing 432, for example, a single-part or multi-part housing. The fluid flow path from the exhaust manifold 116 to the turbine 422 may include a variable nozzle (not shown), which may control the velocity of exhaust fluid impinging on the turbine wheel 428.

The first compressor 424 may include a compressor wheel 434 carried by the shaft 430, and the second compressor 444 may include a compressor wheel 450 carried by the shaft 430. Thus, rotation of the shaft 430 by the turbine wheel 428 in turn may cause rotation of the first and second compressor wheels 434, 450. The first and second compressors 424, 444 may provide first and second stages of pressurization, respectively.

The turbocharger 420 may include an air intake line 436 providing fluid communication between the atmosphere and the first compressor 424 and a compressed air duct 438 for receiving compressed air from the first compressor 424 and supplying the compressed air to the second compressor 444. The turbocharger 420 may include an air outlet line 452 for supplying compressed air from the second compressor 444 to the intake manifold 114 of the engine 110. The turbocharger 420 may also include an exhaust outlet 454 for receiving exhaust fluid from the turbine 422 and providing fluid communication with the atmosphere.

For example, the first compressor 424 and second compressor 444 may both provide compression ratios of between 2 to 1 and 3 to 1, resulting in a system compression ratio of at least 4:1 with respect to atmospheric pressure. Alternatively, the second compressor 444 may provide a compression ratio of 3 to 1 and the first compressor 424 may provide a compression ratio of 1.5 to 1, resulting in a system compression ratio of 4.5 to 1 with respect to atmospheric pressure.

The air supply system 400 may include an air cooler 456 between the compressor 424 and the intake manifold 114. Optionally, the air supply system 400 may include an additional air cooler 458 between the first compressor 424 and the second compressor 444 of the turbocharger 420. Alternatively, the air supply system 400 may optionally include an additional air cooler (not shown) between the air cooler 456 and the intake manifold 114.

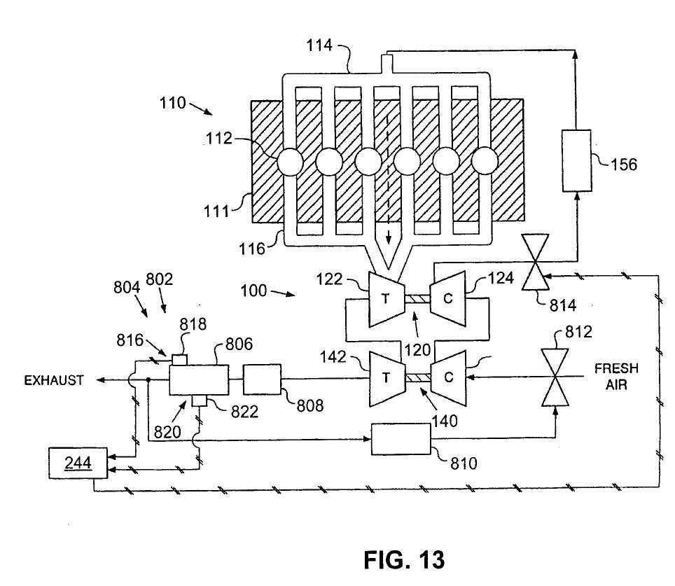

FIG. 13 shows an exemplary exhaust gas recirculation (EGR) system 804 in an exhaust system 802 of combustion engine 110. Combustion engine 110 includes intake manifold 114 and exhaust manifold 116. Engine block 111 provides housing for at least one cylinder 112. FIG. 13 depicts six cylinders 112; however, any number of cylinders 112 could be used, for example, three, six, eight, ten, twelve, or any other number. The intake manifold 114 provides an intake path for each cylinder 112 for air, recirculated exhaust gases, or a combination thereof. The exhaust manifold 116 provides an exhaust path for each cylinder 112 for exhaust gases.

In the embodiment shown in FIG. 13, the air supply system 100 is shown as a two-stage turbocharger system. Air supply system 100 includes first turbocharger 120 having turbine 122 and compressor 124. Air supply system 100 also includes second turbocharger 140 having turbine 142 and compressor 144. The two-stage turbocharger system operates to increase the pressure of the air and exhaust gases being delivered to the cylinders 112 via intake manifold 114, and to maintain a desired air to fuel ratio during extended open durations of intake valves. It is noted that a two-stage turbocharger system is not required for operation of the present invention. Other types of turbocharger systems, such as a high pressure ratio single-stage turbocharger system, a variable geometry turbocharger system, and the like, may be used instead. Alternatively, one or more superchargers or other types of compressors may be used.

A throttle valve 814, located between compressor 124 and intake manifold 114, may be used to control the amount of air and recirculated exhaust gases being delivered to the cylinders 112. The throttle valve 814 is shown between compressor 124 and an aftercooler 156. However, the throttle valve 814 may be positioned at other locations, such as after aftercooler 156. Operation of the throttle valve 814 is described in more detail below.

The EGR system 804 shown in FIG. 13 is typical of a low pressure EGR system in an internal combustion engine. Alternatively, variations of the EGR system 804 may be equally used, including both low pressure loop and high pressure loop EGR systems. Other types of EGR systems, such as for example by-pass, venturi, piston-pumped, peak clipping, and back pressure, could be used.

An oxidation catalyst 808 receives exhaust gases from turbine 142, and serves to reduce HC emissions. The oxidation catalyst 808 may also be coupled with a De-NOₓ catalyst to further reduce NOₓ emissions. A particulate matter (PM) filter 806 receives exhaust gases from oxidation catalyst 808. Although oxidation catalyst 808 and PM filter 806 are shown as separate items, they may alternatively be combined into one package.

Some of the exhaust gases are delivered out the exhaust from the PM filter 806. However, a portion of exhaust gases are rerouted to the intake manifold 114 through an EGR cooler 810, through an EGR valve 812, and through first and second turbochargers 120, 140. EGR cooler 810 may be of a type well known in the art, for example a jacket water or an air to gas heat exchanger type.

A means 816 for determining pressure within the PM filter 806 is shown. In one embodiment, the means 816 for determining pressure includes a pressure sensor 818. However, other alternate means 816 may be employed. For example, the pressure of the exhaust gases in the PM filter 806 may be estimated from a model based on one or more parameters associated with the engine 110. Parameters may include, but are not limited to, engine load, engine speed, temperature, fuel usage, and the like.

A means 820 for determining flow of exhaust gases through the PM filter 806 may be used. The means 820 for determining flow of exhaust gases may include a flow sensor 822. The flow sensor 822 may be used alone to determine pressure in the PM filter 806 based on changes in flow of exhaust gases, or may be used in conjunction with the pressure sensor 818 to provide more accurate pressure change determinations.

### INDUSTRIAL APPLICABILITY

During use, the internal combustion engine 110 may operate in a known manner using, for example, the diesel principle of operation. The engine 110 can be used in a variety of applications. For example, the engine 110 may be provided on board a prime-mover, vehicle or the like, or any type of machine requiring the provision of mechanical or electrical energy. Such machines may include, but are not limited to, earth moving machines, backhoes, graders, rock crushers, pavers, skid-steer loaders, cranes, automobiles, trucks, and the like.

Referring to the exemplary air supply system shown in FIG. 1, exhaust gas from the internal combustion engine 110 is transported from the exhaust manifold 116 through the inlet duct 126 and impinges on and causes rotation of the turbine wheel 128. The turbine wheel 128 is coupled with the shaft 130, which in turn carries the compressor wheel 134. The rotational speed of the compressor wheel 134 thus corresponds to the rotational speed of the shaft 130.

The exemplary fuel supply system 200 and cylinder 112 shown in FIG. 2 may be used with each of the exemplary air supply systems 100, 300, 400. Compressed air is supplied to the combustion chamber 206 via the intake port 208, and exhaust air exits the combustion chamber 206 via the exhaust port 210. The intake valve assembly 214 and the exhaust valve assembly 216 may be controllably operated to direct airflow into and out of the combustion chamber 206.

In a conventional Otto or diesel cycle mode, the intake valve 218 moves from the second position to the first position in a cyclical fashion to allow compressed air to enter the combustion chamber 206 of the cylinder 112 at near top center of the intake stroke 406 (about 360° crank angle), as shown in FIG. 9. At near bottom dead center of the compression stroke (about 540° crank angle), the intake valve 218 moves from the first position to the second position to block additional air from entering the combustion chamber 206. Fuel may then be injected from the fuel injector assembly 240 at near top dead center of the compression stroke (about 720° crank angle).

In a Miller cycle engine, the conventional Otto or diesel cycle is modified by moving the intake valve 218 from the first position to the second position at either some predetermined time before bottom dead center of the intake stroke 406 (i.e., before 540° crank angle) (to provide early intake valve closing) or some predetermined time after bottom dead center of the compression stroke 407 (i.e., after 540° crank angle) (to provide late intake valve closing). In a conventional late-closing Miller cycle, the intake valve 218 is moved from the first position to the second position during a first portion of the first half of the compression stroke 407.

The variable intake valve closing mechanism 238 enables the engine 110 to be operated in a late-closing Miller cycle, an early-closing Miller cycle, and/or a conventional Otto or diesel cycle. Further, injecting a substantial portion of fuel after top dead center of the combustion stroke 508, as shown in FIG. 5, may reduce NOₓ emissions and increase the amount of energy rejected to the exhaust manifold 116 in the form of exhaust fluid. Use of a high-efficiency turbocharger 320, 420 or series turbochargers 120, 140 may enable recapture of at least a portion of the rejected energy from the exhaust. The rejected energy may be converted into increased air pressures delivered to the intake manifold 114, which may increase the energy pushing the piston 212 against the crankshaft 213 to produce useable work. In addition, delaying movement (and/or causing early movement) of the intake valve 218 to its closed position may reduce the compression temperature in the combustion chamber 206. The reduced compression temperature may further reduce NOₓ emissions.

The controller 244 may operate the variable intake valve closing mechanism 238 (e.g., actuator 233) to vary the timing of the intake valve assembly 214 to achieve desired engine performance based on one or more engine conditions, for example, engine speed, engine load, engine temperature, boost, and/or manifold intake temperature. The variable intake valve closing mechanism 238 may also allow more precise control of the air/fuel ratio. By delaying and/or advancing closing of the intake valve assembly 214, the controller 244 may control the cylinder pressure during the compression stroke of the piston 212. For example, late closing of the intake valve reduces the compression work that the piston 212 must perform without compromising cylinder pressure and while maintaining a standard expansion ratio and a suitable air/fuel ratio.

The high pressure air provided by the exemplary air supply systems 100, 300, 400 may provide extra boost on the induction stroke of the piston 212. The high pressure may also enable the intake valve assembly 214 to be closed even later (and/or even earlier) than in a conventional Miller cycle engine. For example, the intake valve assembly 214 may remain open until the second half of the compression stroke of the piston 212, for example, as late as about 80° to 70° before top dead center (BTDC). While the intake valve assembly 214 is open, air may flow between the chamber 206 and the intake manifold 114. Thus, the cylinder 112 may experience less of a temperature rise in the chamber 206 during the compression stroke of the piston 212.

Since the closing of the intake valve assembly 214 may be delayed, the timing of the fuel supply system may also be retarded. For example, the controller 244 may controllably operate the fuel injector assembly 240 to supply fuel to the combustion chamber 206 after the intake valve assembly 214 is closed. For example, the fuel injector assembly 240 may be controlled to supply a pilot injection of fuel contemporaneous with or slightly after the intake valve assembly 214 is closed and to supply a main injection of fuel contemporaneous with or slightly before combustion temperature is reached in the chamber 206. As a result, a significant amount of exhaust energy may be available for recirculation by the air supply system 100, 300, 400, which may efficiently extract additional work from the exhaust energy.

Referring to the exemplary air supply system 100 of FIG. 1, the second turbocharger 140 may extract otherwise wasted energy from the exhaust stream of the first turbocharger 120 to turn the compressor wheel 150 of the second turbocharger 140, which is in series with the compressor wheel 134 of the first turbocharger 120. The extra restriction in the exhaust path resulting from the addition of the second turbocharger 140 may raise the back pressure on the piston 212. However, the energy recovery accomplished through the second turbocharger 140 may offset the work consumed by the higher back pressure. For example, the additional pressure achieved by the series turbochargers 120, 140 may do work on the piston 212 during the induction stroke of the combustion cycle. Further, the added pressure on the cylinder resulting from the second turbocharger 140 may be controlled and/or relieved by using the late intake valve closing. Thus, the series turbochargers 120, 140 may provide fuel efficiency via the air supply system 100, and not simply more power.

It should be appreciated that the air cooler 156, 356, 456 preceding the intake manifold 114 may extract heat from the air to lower the inlet manifold temperature, while maintaining the denseness of the pressurized air. The optional additional air cooler between compressors or after the air cooler 156, 356, 456 may further reduce the inlet manifold temperature, but may lower the work potential of the pressurized air. The lower inlet manifold temperature may reduce the NOₓ emissions.

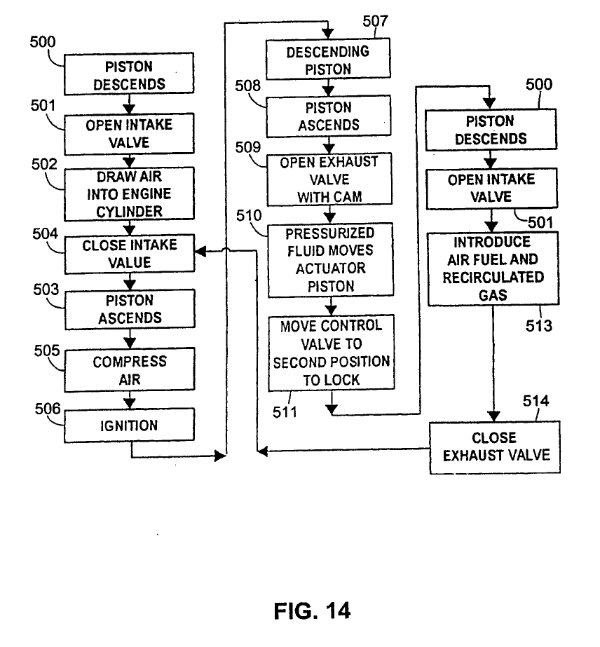

Referring now to FIG. 14, in conjunction with FIGS. 5-8, the engine 110 may be operated so as to open an engine valve and hold an engine valve open in the following manner.

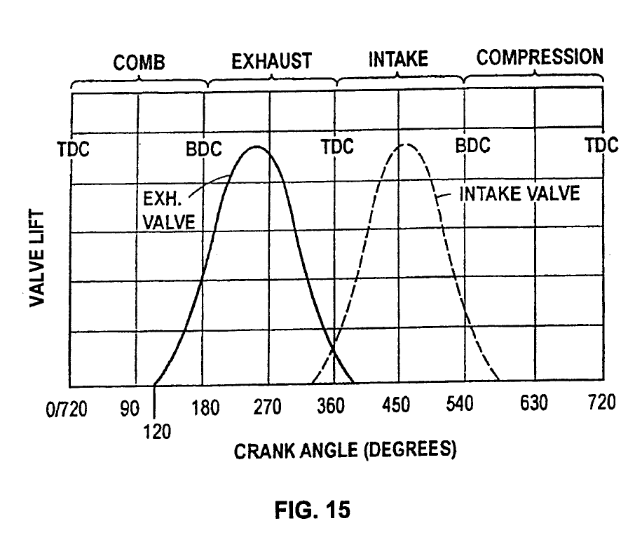

By way of background, one of ordinary skill in the art will understand that a typical four-stoke, diesel cycle, internal combustion engine operates through four distinct strokes the piston 212 through the cylinder 112. In a first or intake stroke, the engine piston 212 descends through the engine cylinder 112 away from the cylinder head 211 while the intake valve 218 is opened by the cam assembly 290, as indicated in steps 500 and 501, respectively. FIG. 15 depicts an example the intake valve 218 and exhaust valve 219 lift of a typical diesel cycle engine wherein engine operation is plotted as seven hundred and twenty degrees of engine crank angle, and with each of the four strokes representing 180° of rotation of the crank shaft 213. In so doing, air is drawn into the engine cylinder 112, as indicated in a step 502.

In a second or compression stroke, the engine piston 212 reverses its motion, at the direction of the rod 215, while the intake and exhaust valves 218, 219 are closed with springs 228. Such steps are indicated by reference numerals 503 and 504, respectively in FIG. 14. As the engine piston 212 ascends through the engine cylinder 112 toward the cylinder head 211, air is compressed (as indicated by a step 505).

In a third or combustion stroke, fuel is injected directly into the compressed air and thereby is ignited, as indicated by a step 506. The resulting explosion and expanding gases push the engine piston 212 again in a descending direction (as indicated by a step 507) through the engine cylinder 112, while the intake and exhaust valves 218, 219 remain closed.

In a fourth or exhaust stroke, the engine piston 212 again reverses and ascends through the engine cylinder 112, but with the exhaust valve 219 open by the cam assembly 290, thereby pushing the combustion gases out of the engine cylinder 112. Such steps are indicated in FIG. 14 as steps 508 and 509, respectively.

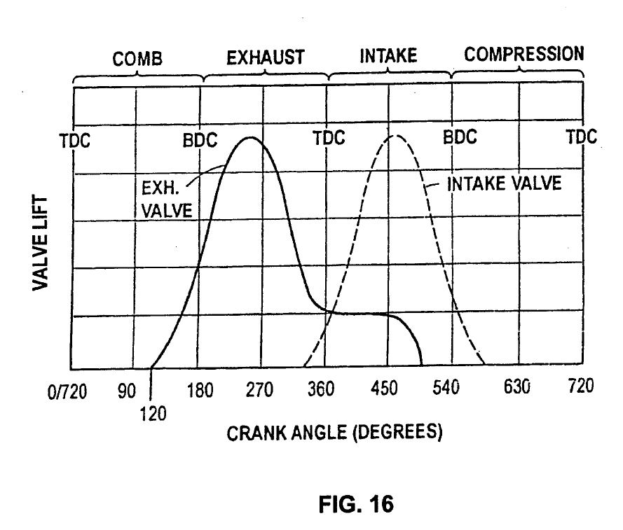

With certain engine operation variations, such as compression release braking, Miller cycle operation, and EGR, it may be desirable to alter the above valve timing and hold one or more valves open against substantial cylinder pressures. The teachings of the present disclosure may enable such operation, possibly without resort to highly pressurized oil rails, thereby preserving engine efficiency and simplicity. Taking internal EGR as an example, it is necessary in such operation for the exhaust valve 219 (or intake valve 218) to remain open throughout not only the exhaust stroke, but during an interim period between when the exhaust valve 219 is normally closed and when the intake valve 218 opens to conduct the intake stroke. FIG. 16 depicts an example of such altered valve timing in graphical form.

This can be accomplished by allowing the cam assembly 290 to open the exhaust valve 219 according to a normal exhaust stroke as indicated above (step 509), and then using the actuator 233 to maintain the exhaust valve 219 in an open position. More specifically, as the cam assembly 233 moves to open the exhaust valve 219, the rocker arm 226 pivots downwardly compressing the spring 228. With the spring pressure overcome by the cam assembly 233, the pressurized fluid flowing from the low pressure source 245 and filling the actuation chamber 243 is able to move the piston 237. The piston 237 moves through the lash 263 until the actuator rod 265 engages the rocker arm 226. This step is indicated by reference numeral 510 in FIG. 14.

In order to hold the exhaust valve 219 in such a position even after the cam 234 rotates to another position, the control valve 248 is switched from the first position (shown in FIG. 7) to the second position (shown in FIG. 8), as indicated by a step 511. In so doing, the fluid is locked from escaping the actuation chamber 243 and, due to its incompressibility, prevents the actuator piston 237 from moving and, thus, prevents the exhaust valve 219 from closing. As used herein, an “hydraulically locked” device is defined as a device having substantially no fluid flow and substantially no fluid leakage, and “backflow” is defined as fluid flow from the actuator 233 to the low pressure fluid source 245.

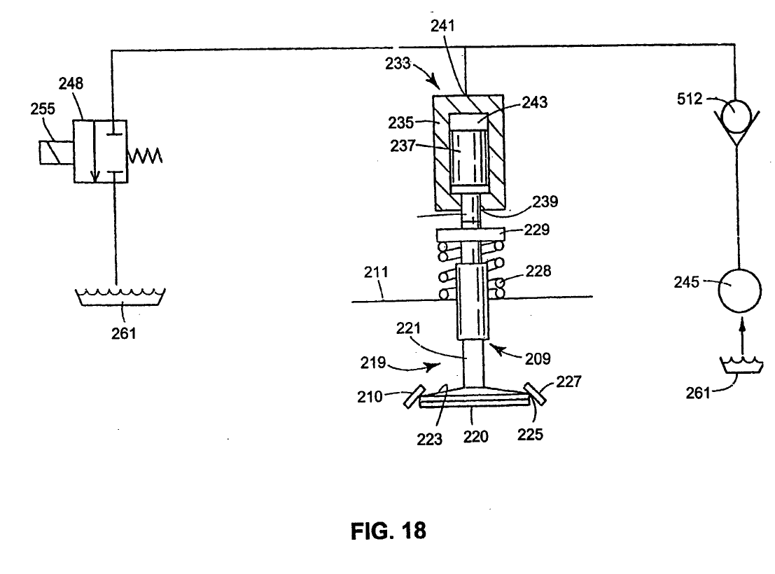

In addition to the above example, the actuator 233 may be hydraulically locked using any number of other devices including, but not limited to, check valves. For example, as shown in FIG. 18, a check valve 512 may be provided between the actuator 233 and the low pressure source 245. The check valve allows the fluid from source 245 to enter the actuator cylinder 235 and move the actuator piston 237, but not flow back to the source 245. In conjunction with such structure, a normally closed control valve 248 may be provided also in communication with the low pressure source 245 (or drain 261 or atmosphere). Upon actuation of solenoid 255 of the control valve 248, the fluid pressure with the actuator cylinder 235 is able to flow to the low pressure source 245 or drain 261. In so doing, the actuator piston 237 is able to move up, closing the valve 218, 219.

Continuing with the example of EGR, the exhaust valve 219 is held open as the engine piston 212 ascends to a top dead center position, and remains open after the engine piston 212 reverses and descends while the intake valve 218 is opened, as indicated by steps 500 and 501, respectively. A portion of the exhaust gases vented from the engine cylinder 112 through the exhaust valve 219 is thereby reintroduced to the engine cylinder 112 by the resulting pressure differential. This step is indicated by reference numeral 513. After a predetermined stroke length (e.g., ninety degrees of a seven hundred and twenty degree four stroke cycle as shown in FIG. 16), the exhaust valve 219 is closed as indicated by a step 514, while the intake valve 218 remains open to complete the intake stroke as explained above. The exhaust valve 219 may be closed by switching the control valve 248 back to the first position (shown in FIG. 7) and thereby enabling the spring 228 to push the actuator piston 237 up, and the pressurized fluid out of, the actuator cylinder 235. Normal engine operation may then resume, beginning with the compression stroke as indicated in FIG. 14.

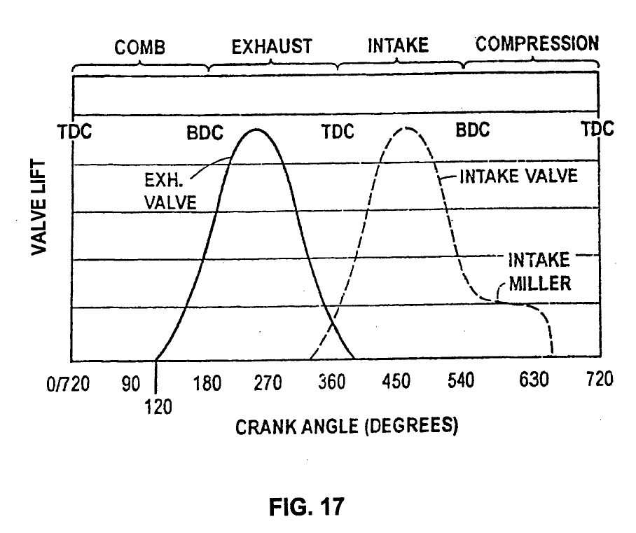

The teachings of the present disclosure can also be used to provide Miller cycle benefits. As illustrated in the example of FIG. 17, the intake valve 218 (or exhaust valve 219) may be held open during the initial stages of the compression stroke to thereby reduce the compression ratio of the engine and provide the engine efficiencies of the Miller cycle as well known by those of ordinary skill in the art. The intake valve 218 could be so held by employing the actuator 233 after the cam assembly 290 opens the intake valve during the intake stroke. More specifically, as the intake valve 218 is about to be closed by the spring 228 at the conclusion of a normal intake stroke, the control valve 248 could be actuated so as to prevent fluid flow from the actuator 233 back to the low pressure fluid source 245. In so doing, the actuator piston 237 is locked in position, as is the intake valve 218 as depicted in FIG. 17.

Although some examples described herein involve late intake valve closure, it should be understood that certain examples in accordance with the invention might involve engine operation where both late and early intake valve closure is provided or engine operation where only early intake is selectively provided. For example, in some exemplary engines including camshaft 232, the cams 234 could have an alternative profile providing cyclical early intake valve closure and the actuator 233 may be controlled to selectively delay the intake valve closing so that the delayed intake valve closing occurs before, at, and/or after bottom dead center of the intake stroke.

One of ordinary skill in the art will understand that significant force may be required to open the intake and exhaust valves 218, 219, and hold the valves open, during the compression and exhaust strokes, due to the ascending piston and pressurized gases being pushed out of the engine cylinder 112 and thus against the valves 218, 219. The actuator 233, and its ability to become hydraulically locked, may be able to hold the valves 218, 219 open under such conditions, possibly without resort to high pressure rails and the drops in engine efficiency incumbent with conventional systems.

Referring again to FIG. 13, a change in pressure of exhaust gases passing through the PM filter 806 results from an accumulation of particulate matter, thus indicating a need to regenerate the PM filter 806, i.e., burn away the accumulation of particulate matter. For example, as particulate matter accumulates, pressure in the PM filter 806 increases.

The PM filter 806 may be a catalyzed diesel particulate filter (CDPF) or an active diesel particulate filter (ADPF). A CDPF allows soot to burn at much lower temperatures. An ADPF is defined by raising the PM filter internal energy by means other than the engine 110, for example electrical heating, burner, fuel injection, and the like.

One method to increase the exhaust temperature and initiate PM filter regeneration is to use the throttle valve 814 to restrict the inlet air, thus increasing exhaust temperature. Other methods to increase exhaust temperature include variable geometry turbochargers, smart wastegates, variable valve actuation, and the like. Yet another method to increase exhaust temperature and initiate PM filter regeneration includes the use of a post injection of fuel, i.e., a fuel injection timed after delivery of a main injection.

The throttle valve 814 may be coupled to the EGR valve 812 so that they are both actuated together. Alternatively, the throttle valve 814 and the EGR valve 812 may be actuated independently of each other. Both valves may operate together or independently to modulate the rate of EGR being delivered to the intake manifold 114.

CDPFs regenerate more effectively when the ratio of NOₓ to particulate matter, i.e., soot, is within a certain range, for example, from about 20 to 1 to about 30. In some examples, an EGR system combined with the above described methods of multiple fuel injections and variable valve timing may result in a NOₓ to soot ratio of about 10 to 1. Thus, it may be desirable to periodically adjust the levels of emissions to change the NOₓ to soot ratio to a more desired range and then initiate regeneration. Examples of methods which may be used include adjusting the EGR rate and adjusting the timing of main fuel injection.

A venturi (not shown) may be used at the EGR entrance to the fresh air inlet. The venturi would depress the pressure of the fresh air at the inlet, thus allowing EGR to flow from the exhaust to the intake side. The venturi may include a diffuser portion which would restore the fresh air to near original velocity and pressure prior to entry into compressor 144. The use of a venturi and diffuser may increase engine efficiency.

An air and fuel supply system for an internal combustion engine in accordance with the exemplary embodiments of the invention may extract additional work from the engine's exhaust. The system may also achieve fuel efficiency and reduced NOₓ, emissions, while maintaining work potential and ensuring that the system reliability meets with operator expectations.

It will be apparent to those skilled in the art that various modifications and variations can be made to the subject matter disclosed herein without departing from the invention. Other embodiments of the invention will be apparent to those skilled in the art from consideration of the specification and practice of the invention disclosed herein. It is intended that the specification and examples be considered as exemplary only.

1. A method of operating an internal combustion engine including at least one cylinder and a piston slidable in the cylinder, the method comprising:
supplying pressurized air from an intake manifold to an air intake port of a combustion chamber in the cylinder;
injecting fuel into the combustion chamber; and
operating an air intake valve to open the air intake port to allow pressurized air to flow between the combustion chamber and the intake manifold substantially during a majority portion of a compression stroke of the piston,
wherein said selectively operating includes operating a fluidically controlled actuator to hold the intake valve open.

2-72. (canceled)
